(19) United States
(12) Patent Application Publication
(10) Pub. No.: US 2014/0269476 A1
(43) Pub. Date: Sep. 18, 2014

(54) POWER MANAGEMENT FOR WIRELESS ACCESS POINT

(71) Applicant: FlowNet LLC, Williamsville, NY (US)

(72) Inventors: William C. Weston, New Braunfels, TX (US); John F. Meyo, Lancaster, NY (US)

(73) Assignee: FlowNet LLC, Williamsville, NY (US)

(21) Appl. No.: 14/203,746

(22) Filed: Mar. 11, 2014

Related U.S. Application Data
(60) Provisional application No. 61/781,130, filed on Mar. 14, 2013.

(51) Int. Cl. H04W 52/02

(52) U.S. Cl. CPC H04W 52/0206
USPC 370/311

(57) ABSTRACT

A method and apparatus for power management of a wireless access point associated with a host device. The wireless access point is instructed to transition from a sleep mode to an active mode. The wireless access point then returns to the sleep mode, independent of any instruction from the host device, if no probe request has been received from an authorized client in a predetermined interval of time.

### CROSS-REFERENCE TO RELATED APPLICATIONS

The present application claims priority to U.S. Provisional Patent Application Ser. No. 61/781,130 filed Mar. 14, 2013 entitled POWER MANAGEMENT FOR WIRELESS ACCESS POINT, the entire contents of which is being incorporated herein by reference in its entirety for all purposes.

### BACKGROUND

The present disclosure relates to a wireless access point transceiver and method, and more particularly, a wireless access point with power conservation systems and operation. A wireless access point is a device that allows wireless devices to connect to a network using Wi-Fi, or related standards. The access point usually connects to a router via a wired network if it is a standalone device, or the access point can itself be part of a router. Most access points support the connection of multiple wireless devices to one wired connection. Modern access points are built to support a standard for sending and receiving data using these radio frequencies. Those standards, and the frequencies they use, are defined by the Institute of Electrical and Electronics Engineers (IEEE). Most access points use IEEE 802.11 standards.

### SUMMARY

In accordance with an aspect of the present invention, a wireless access point apparatus includes a transceiver assembly configured to transmit and receive radio frequency (RF) signals at an associated antenna and a processor. The system further includes a non-transitory computer readable medium operatively connected to the processor storing machine executable instructions. These instructions include a media access control (MAC) database containing a list of MAC addresses associated with respective clients. A system control is configured to, upon entrance of the wireless access point into an active mode, return the wireless access point to a sleep mode after a predetermined interval unless a probe request from an authorized client is received at the transceiver assembly. The system control determines if a client is authorized from a MAC address associated with the probe request and the list of MAC addresses in the MAC database.

In accordance with another aspect of the present invention, a method is provided for power management of a wireless access point associated with a host device. The wireless access point is instructed to transition from a sleep mode to an active mode. The wireless access point then returns to the sleep mode, independent of any instruction from the host device, if no probe request has been received from an authorized client in a predetermined interval of time.

In accordance with yet another aspect of the present invention, a wireless sensor system includes a sensor configured to produce sensor data representing a sensed parameter and a wireless access point apparatus configured to provide sensor data from the sensor to authorized clients. The wireless access point apparatus includes a transceiver assembly configured to transmit and receive radio frequency (RF) signals at an associated antenna and a processor. The system further includes a non-transitory computer readable medium operatively connected to the processor storing machine executable instructions. These instructions include a media access control (MAC) database containing a list of MAC addresses associated with respective clients. A system control is configured to, upon entrance of the wireless access point into an active mode, return the wireless access point to a sleep mode after a predetermined interval unless a probe request from an authorized client is received at the transceiver assembly. The system control determines if a client is authorized from a MAC address associated with the probe request and the list of MAC addresses in the MAC database. A power source, including a battery that is charged by one of a solar panel and a wind turbine, is configured to provide power to each of the host system and the wireless access point assembly.

### BRIEF DESCRIPTION OF THE SEVERAL VIEWS OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals, unless otherwise described refer to like parts throughout the drawings and in which:

FIG. 1 is a block diagram illustrating a host system configured to communicate intermittently with one or more clients via a wireless access point in accordance with some embodiments;

FIG. 2 is a flowchart of a method for wirelessly providing sensor data in accordance with some embodiments;

FIG. 3 illustrates a method for providing data from a wireless natural gas flow computer in accordance with some embodiments;

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements having similar characteristics and operational properties throughout unless otherwise noted. The present disclosure relates to a WIFI access point modulator and method, and more particularly, a WIFI access point with power conversation systems and operation.

There is no provision in the IEEE 802.11 WiFi standard for an access point sleep mode. In the vast majority of applications, a wireless access point is connected to utility power or another reliable power source and clients are frequently, or even constantly, present and communicating, making an access point sleep mode unnecessary and impractical. In some applications, access points can be instructed by their host devices to transition between sleep and active modes to reduce power consumption. However, this reduction in power consumption is accompanied by a corresponding reduction in responsiveness.

In order for two devices to communicate using WiFi, they must first establish a virtual connection. The WiFi standard includes a variety of data rates, security measures, and other parameters that are negotiated between the two devices in order to establish the connection. The client device, for example, a smart phone, laptop computer, or tablet computer, sends a probe request message includes a unique address identifying the client device. In practice, client devices typically send probe requests in periodic bursts. Any access point that receives the probe request sends a probe response. The probe response provides information identifying the access point and some of its capabilities. If the client device wants to connect to the access point, it initiates the process by sending an authentication request. The complete process of establishing the connection involves a sequence of messages between the two devices. If a client device has proper credentials for joining the network hosted by the access point, the connection is established. If the client does not have proper credentials, it is not allowed to join the network.

For machine-to-machine communications, the access point is either connected to or integrated with a host device. It is the host device that ultimately communicates with the client device through the access point. Existing access points that support sleep modes utilize commands by the host device to the access point to enter and exit sleep mode. Access points notify their host device only when a client has joined the network, not when a probe request is received, as the large number of probe requests received by a given access point would be infeasible to communicate to the host. The authentication process, measured from the time the probe request is received to the time the connection is completed, can take well over a second. Given that a typical client device tends to send out bursts of probe requests at intervals ranging from six to ten seconds, the host device would need to keep the access point active for at least twelve seconds to ensure that no clients are trying to connect. Unless the periods of activity are separated by unacceptably long periods of unresponsiveness, it is difficult to realize any significant reduction in power consumption.

FIG. 1 is a block diagram illustrating a host system 12 configured to communicate intermittently with one or more clients (not shown) via a wireless access point 14. The wireless access point 14 includes a transceiver (Tx/Rx) assembly 16 configured to modulate provided data onto a radio frequency carrier and transmit it through an antenna 18 operatively connected to the transceiver assembly, as well as demodulate and digitize signals received at the antenna to provide data in a useful form for digital processing.

The wireless access point 14 further includes a processor 19 operatively connected to a non-transitory computer readable medium 20, such that the processor can execute machine executable instructions stored on the non-transitory computer readable medium. For example, the non-transitory computer readable medium 20 can store a firmware of the wireless access point 14. These machine executable instructions 20 include a transceiver interface 22 configured to provide appropriately formatted signals for transmission at the transceiver assembly 16 and to condition signals for analysis at an associated system control 24. The transceiver interface 22 can further be configured to provide commands, such as a command to enter a sleep mode, and configuration data, such as frequency values for numerically controlled oscillators to the transceiver assembly 16.

The system control 24 is a set of digital logic for authenticating clients and communicating with the host device. In one example, a client is determined to be authorized if and only if the Media Access Control (MAC) address of the client, as provided in its probe request, is determined to be on a white list of MAC addresses stored in a MAC address database 26. Alternatively, the client can be determined to be authorized whenever the MAC address of the client is not on a black list stored in the MAC address database 26.

The illustrated wireless access point 14 is ideal for an application in which the client devices will be only intermittently within range of the access point and available power from an associated power source 30 is limited in some manner. One application could include wireless sensors, which are often installed in locations in which it is infeasible to provide utility power. For example, the power source 30 can include a battery that is charged by a solar panel or wind turbine. It will be appreciated that the availability of these power sources can be unpredictable, such that the wireless access point 14 could potentially have to rely on minimal power for reasonably long periods of time. Unfortunately, the wireless sensors are read by at irregular intervals, such that the access point must be substantially responsive to probe requests from clients at all times.

To this end, the system control 24 is configured to utilize a sleep/wake cycling process to reduce the power consumption of the wireless access point while retaining responsiveness to comparable to remaining in a constant active mode. To this end, the wireless access device 14 enters an active mode at regular intervals, for example, every one or two seconds. This can be accomplished either by an instruction from the host device 12 or digital logic at the system control 24 configured to wake the digital access point 14 at regular intervals.

In accordance with an aspect of the present invention, the system control 24 is configured to send the system into a sleep mode whenever the system has been active for more than a predetermined period of time, for example, between one hundred and two hundred milliseconds, without receiving a probe request from an authorized client. It will be appreciated that this function is completely independent of the host device 12; no external instruction is required for the wireless access point to reenter sleep mode if no authorized probe request is received. Accordingly, a power consumption of the device can be reduced by a factor of ten while retaining significant responsiveness to incoming clients. It will be appreciated that the one or two seconds of inactivity associated with the wireless access point 14 are significantly shorter than the six to ten seconds between burst of probe requests provided by most clients, such that the periodic inactivity of the wireless access point will be imperceptible to users.

FIG. 2 is a flowchart illustrating a method 50 for wirelessly providing data from a host device in accordance with an aspect of the present invention. At 52, the wireless access point is instructed to transition from a sleep mode to an active mode. In the illustrated implementation, this occurs approximately every one to two seconds. In one implementation, the host device sends a command to the wireless access point to wake up the device. In another implementation, digital logic at the wireless access point is configured to wake the device at scheduled intervals. At 54, it is determined if a probe request has been received from an authorized client. If so (Y), the method advances to 56 where the wireless access point begins an authentication process with the authorized client and notifies the host device that the client is present. Otherwise, the method continues to 58.

At 58, it is determined if a timeout period has elapsed. In accordance with an aspect of the present invention, this timeout period will be very short, for example, between one hundred and two hundred milliseconds. In practice, the timeout period will be determined as the sum of an expected maximum interval between probe requests from a client device generally used to collect the sensor data and the duration of a probe request message. If the timeout period has not elapsed (N), the method 50 returns to 54 to wait for a probe request. If the timeout period has elapsed (Y), the method advances to 60, where in access point immediately returns to sleep mode, without further communication with the host device.

FIG. 3 illustrates a method 100 for providing data from a wireless natural gas flow computer in accordance with an aspect of the present invention. For example, a natural gas flow computer can use a wireless access point in accordance with an aspect of the present invention to replace wired communications. Users can connect to the flow computer with smart phones, tablets, laptop computers, and other devices to perform configuration, calibration, and data collection functions. Typically these functions are only required at infrequent intervals. The illustrated method modifies the power consumption associated with wireless communication via WiFi access points to be compatible with the limited power available to most gas flow computers.

The method 100 begins at 102, when the host device associated with the flow computer commands the access point to transition from a sleep mode to an active mode. The access point can wake up from sleep mode and check for Probe Request messages within less than a millisecond. At 104 and 106, the access point waits for a preset interval to receive a probe request. The preset interval is based on the expected maximum interval between client device probe request messages plus the duration of a probe request message. Typically this interval will be between one hundred and two hundred milliseconds. If no probe request message is detected during this interval (N at 106), the access point goes back to sleep at 108. In order to achieve a 10:1 power reduction during times when no client is present, the access point must then sleep for at least one to two seconds.

If a probe request message is detected (Y, at 104), the simplest course of action would be for the access point to notify the host device immediately. Upon receiving this notification, the host device would wait long enough for a client device to establish a connection (e.g., up to three seconds). In this scenario, the desired power reduction goal would be met during times when no client devices were present. However, if any client device is present, regardless of whether it is authorized to join the network, its probe request messages could result in keeping the access point awake continuously.

The method 100 is therefore designed to ensure that only authorized clients cause the access point to signal the host device and stay awake. Every WiFi device has a unique Media Access Control (MAC) address. The probe request message includes the MAC address of the client device. In the illustrated example, the access point keeps two lists of MAC addresses. The white list, or authorized list, contains MAC addresses of authorized clients. The black list, or restricted list, contains MAC addresses of known unauthorized clients.

Accordingly, when the access point receives a probe request at 104, the method 100 advances to 110 to compares the MAC address contained in the probe request with the black list. If the MAC address is on the black list (Y), the access point ignores the probe request at 112 and does not notify the host device. If the MAC address is not on the black list (N), the method advances to 114, where the access point compares the MAC address with the white list. If the address is on the white list (Y), the access point notifies the host device and continues with the 802.11 authentication process at 116.

If the MAC address from the probe request is on neither the white list nor the black list, the method advances to 118 where it is determined if the client should be authorized. At this point, the access point response depends on a configuration option set by an operator. In an open mode, the access point always allows client devices with unlisted access points to connect. Accordingly, if the access point is operating in the open mode (Y), the method advances to 120, where the MAC address is added to the white list, and then to 116 where the access point notifies the host device and continues with the 802.11 authentication process. In a closed mode, the access point only allows devices on the white list to connect. Accordingly, if the access point is operating in the closed mode (N), the method advances to 122, where the MAC address is added to the black list, and then to 112, where the probe request is ignored.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof; are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for power management of a wireless access point associated with a host device, the method comprising:
instructing the wireless access point to transition from a sleep mode to an active mode; and
returning to the sleep mode, independent of any instruction from the host device, if no probe request has been received from an authorized client in a predetermined interval of time.

2. The method of claim 1, further comprising determining if a client is an authorized client by verifying that a media address control (MAC) address of the client is on a list of authorized MAC addresses associated with the wireless access point.

3. The method of claim 1, further comprising determining if a client is an authorized client by verifying that a media address control (MAC) address of the client is not on a list of restricted MAC addresses associated with the wireless access point.

4. The method of claim 1, further comprising:
determining if the wireless access point is configured in an open mode or a closed mode;
determining if a client is an authorized client, when the wireless access point is configured in an open mode, by verifying that a media address control (MAC) address of the client is on a list of authorized MAC addresses associated with the wireless access point; and
determining if the client is an authorized client, when the wireless access point is configured in an closed mode, by verifying that the MAC address of the client is not on a list of restricted MAC addresses associated with the wireless access point/

5. The method of claim 1, wherein instructing the wireless access point to transition from the sleep mode to the active mode comprises providing an instruction from the host device to instruct the wireless access point to transition from the sleep mode to the active mode.

6. The method of claim 1, wherein instructing the wireless access point to transition from the sleep mode to the active mode comprises providing periodic instructions from digital logic associated with the wireless access point to cause the wireless access point to transition into the active mode at regular intervals.

7. The method of claim 6, wherein the regular intervals have a duration between one second and two seconds.

8. The method of claim 7, wherein the predetermined interval of time is between one hundred milliseconds and two hundred milliseconds.

9. The method of claim 1, wherein the predetermined interval is determined as sum of an expected maximum interval between probe requests from an expected client device and the duration of a probe request message from the expected client device.

10. A wireless access point apparatus comprising:
a transceiver assembly configured to transmit and receive radio frequency (RF) signals at an associated antenna;
a processor; and
a non-transitory computer readable medium operatively connected to the processor, the non-transitory computer readable medium storing machine executable instructions comprising:
a media access control (MAC) database containing a list of MAC addresses associated with respective clients; and
a system control configured to, upon entrance of the wireless access point apparatus into an active mode, return the wireless access point to a sleep mode after a predetermined interval unless a probe request from an authorized client is received at the transceiver assembly, the system control determining if a client is authorized from a MAC address associated with the probe request and the list of MAC addresses in the MAC database.

11. The wireless access point apparatus of claim 10, wherein the system control comprises digital logic to provide instructions to cause the wireless access point apparatus to enter into the active mode at regular intervals.

12. The wireless access point apparatus of claim 11, wherein the regular intervals have a duration between one second and two seconds, and the predetermined interval before returning to the sleep mode is between one hundred milliseconds and two hundred milliseconds.

13. The wireless access point apparatus of claim 10, the MAC database comprising a list of authorized MAC addresses and a list of restricted MAC addresses, the system control being configured to determine the client is an authorized client if a MAC address of the client is on the list of authorized MAC addresses and determine the client is not an authorized client if the MAC address of the client is on the list of restricted MAC addresses.

14. The wireless access point apparatus of claim 13, the system control storing a configuration parameter indicating if the wireless access point apparatus is configured in an open mode or a closed mode, the system control being configured to determine that a client having a MAC address not present in the MAC database to be authorized if the system is configured in the open mode, and not authorized if the system is configured to operate in the closed mode.

15. A system comprising:
the wireless access point assembly of claim 10;
a host system configured to communicate intermittently with the authorized clients via the wireless access point assembly; and
a power source configured to provide power to each of the host system and the wireless access point assembly.

16. The system of claim 15, wherein the power source comprises a battery that is charged by one of a solar panel and a wind turbine.

17. The system of claim 15, wherein the host system is a natural gas flow computer.

18. A wireless sensor system comprising:
a sensor configured to produce sensor data representing a sensed parameter;
a wireless access point apparatus configured to provide sensor data from the sensor to authorized clients, the wireless access point apparatus comprising:
a transceiver assembly configured to transmit and receive radio frequency (RF) signals at an associated antenna;
a processor; and
a non-transitory computer readable medium operatively connected to the processor, the non-transitory computer readable medium storing machine executable instructions comprising:
a media access control (MAC) database containing a list of MAC addresses associated with respective clients; and
a system control configured to, upon entrance of the wireless access point apparatus into an active mode, return the wireless access point to a sleep mode after a predetermined interval unless a probe request from an authorized client is received at the transceiver assembly, the system control determining if a client is authorized from a MAC address associated with the probe request and the list of MAC addresses in the MAC database; and
a power source configured to provide power to each of the host system and the wireless access point assembly, the power source comprising a battery that is charged by one of a solar panel and a wind turbine.

19. The wireless sensor system of claim 18, wherein the predetermined interval is between one hundred milliseconds and two hundred milliseconds.

20. The wireless sensor system of claim 18, wherein the sensor is configured to instruct the wireless access point to transition from the sleep mode to the active mode.
